(19) United States
(12) Patent Application Publication
(10) Pub. No.: US 2024/0380021 A1
(43) Pub. Date: Nov. 14, 2024

(54) TEMPERATURE EQUALIZATION AND HEAT DISSIPATION STRUCTURE OF LITHIUM BATTERY

(71) Applicant: AMITA TECHNOLOGIES INC., Taoyuan City (TW)

(72) Inventor: Yuan-Li CHIANG, Taoyuan City (TW)

(21) Appl. No.: 18/221,851

(22) Filed: Jul. 13, 2023

(30) Foreign Application Priority Data
May 10, 2023 (TW) 112117345

(51) Int. Cl. H01M 10/6551; H01M 10/613; H01M 10/647; H01M 10/653; H01M 50/202; H01M 50/224; H01M 50/242; H01M 50/291

(52) U.S. Cl. CPC H01M 10/6551; H01M 10/613; H01M 10/647; H01M 10/653; H01M 50/202; H01M 50/224; H01M 50/242; H01M 50/291

(57) ABSTRACT

A heat dissipation structure of a lithium battery includes a battery cell and a metal housing. The battery cell includes a battery core and two electrode tabs. The metal housing includes a heat dissipation surface having a large area contacting the battery core and a frame surrounding the heat dissipation surface. A buffer space recessed toward the battery cell is formed between the frame and the heat dissipation surface. A plurality of cooling slots is disposed on the frame and communicate with the buffer space and an external environment. Therefore, the deformation space required for the expansion of the battery core is provided to keep the overall appearance of the battery cell, and the effects of uniform and rapid heat dissipation may be achieved.

### BACKGROUND OF THE DISCLOSURE

### Field of the Disclosure

This disclosure generally relates to a lithium battery, and more particular, to a heat dissipation structure of a lithium battery.

### Description of Related Art

In lithium batteries, electrodes of battery cells and electrolyte chemically react to generate electricity. Furthermore, during the charging or discharging process of a lithium battery, a large amount of heat is generated and the internal temperature is increased when electrolyte is ion-exchanged, which leads to a reduction of service life of battery cells and causes danger in use.

On the other hand, during chemical reaction, the electrolyte in the lithium battery may crack to generate gas. While the accumulation of those gas, it may increase the internal pressure, that may cause the positive and negative electrodes of battery cells to be separated from the separation membrane, and may further cause the deformation of the battery cell, even the appearance of the electronic device of the battery cell is affected. Additionally, the heat is not easy to be dissipated after the battery cells stacked inside the lithium battery. In this regard, how to provide a heat dissipation structure of the lithium battery to keep a stable working temperature of the battery core and hold the temperature evenly is the key to improve the service life and safety of the lithium battery.

In view of the above drawbacks, the Inventor proposes this disclosure based on his expert knowledge and elaborate researches in order to solve the problems of related art.

### SUMMARY OF THE DISCLOSURE

Accordingly, an object of this disclosure is to provide a heat dissipation structure of a lithium battery, so as to provide a deformation space required for the expansion and contraction of the electrode tabs during the charging and discharging of the battery cell, and cooling slots are disposed to dissipate heat for adjacent battery cells after being stacked. Thus, the overall appearance of the battery cell is maintained, and the effect of rapid heat dissipation is achieved.

In order to achieve the object mentioned above, this disclosure provides a heat dissipation structure of a lithium battery including a battery cell and a metal housing. The battery cell includes a battery core and two electrode tabs. The metal housing includes a heat dissipation surface having a large area contacting the battery core and a frame surrounding the heat dissipation surface. A buffer space recessed toward the battery cell is formed between the frame and the heat dissipation surface. A plurality of cooling slots is disposed on the frame and communicating with the buffer space and an external environment.

Comparing with the related art, the heat dissipation structure of a lithium battery of this disclosure includes a metal housing covering the battery cell, and the metal housing has a buffer space recessed toward the battery cell between the heat dissipation surface and the frame. Therefore, when the battery core generates gas and the electrode tabs expand or contract, they may expand to the buffer space. Because of the arrangement of the buffer space, the battery core and the electrode tabs may not push the metal housing after expansion and contraction, so that the overall appearance of the battery cell may be maintained. Furthermore, a plurality of cooling slots is disposed on the frame of the metal housing and communicate with the buffer space and the external environment. Thus, heat is dissipated from the cooling slots to achieve the effect of rapid heat dissipation.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a perspective schematic view of the heat dissipation structure of a lithium battery of this disclosure.

FIG. 2 is a perspective exploded view of the heat dissipation structure of a lithium battery of this disclosure.

FIG. 3 is a cross sectional view of the heat dissipation structure of a lithium battery of this disclosure.

FIG. 4 is a partially enlarged view of FIG. 3.

FIG. 5 is a cross sectional view of another embodiment of the heat dissipation structure of a lithium battery of this disclosure.

FIG. 6 is a partially enlarged view of FIG. 5.

FIG. 7 and FIG. 8 are perspective schematic views of another two embodiments of the heat dissipation structure of a lithium battery of this disclosure.

### DETAILED DESCRIPTION

In cooperation with attached drawings, the technical contents and detailed description of the disclosure are described thereinafter according to a number of preferable embodiments, not being used to limit its executing scope. Any equivalent variation or modification made according to appended claims is all covered by the claims claimed by this disclosure.

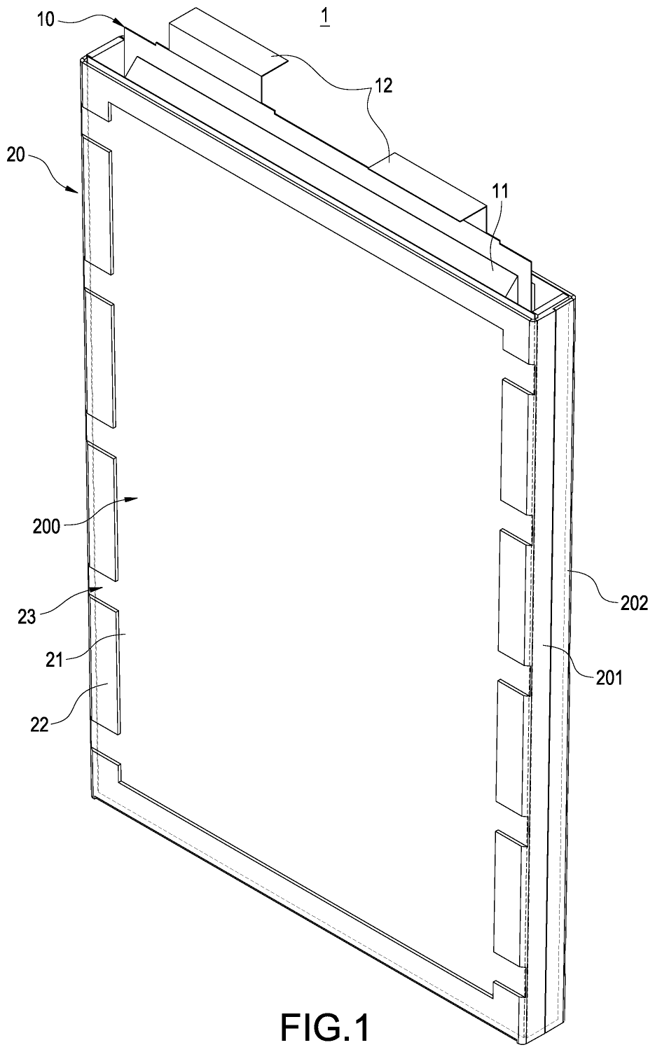

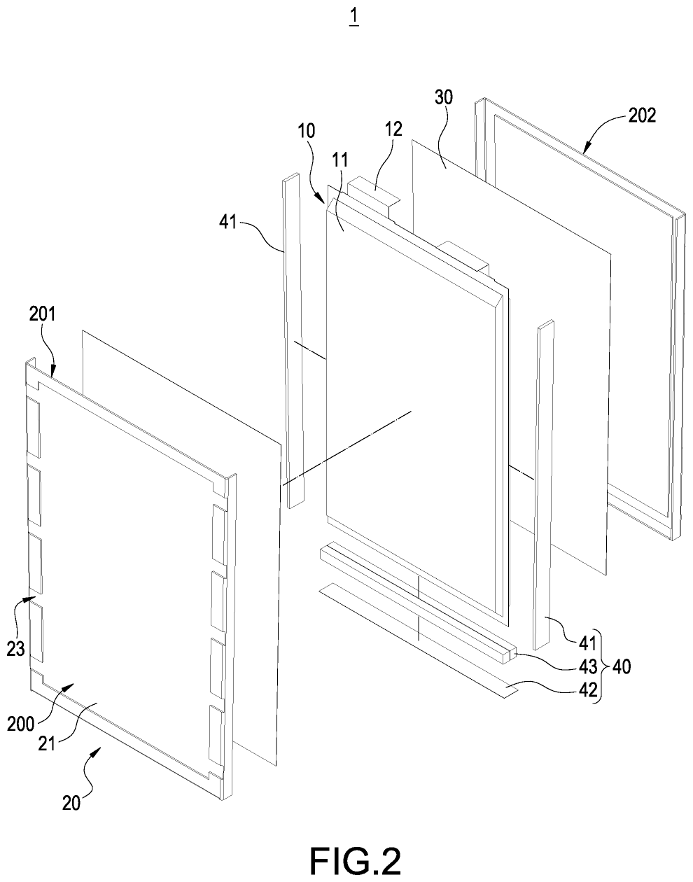

Please refer to FIG. 1 and FIG. 2, they depict a perspective schematic view of the heat dissipation structure of a lithium battery of this disclosure and a perspective exploded view of the lithium battery of this disclosure. This disclosure is a heat dissipation structure 1 includes a battery cell 10 and a metal housing 20. The metal housing 20 covers the battery cell 10 to constitute the temperature homogeneity and heat dissipation structure 1. More detailed description of the heat dissipation structure 1 is as follows.

The battery cell 10 includes a battery core 11 and two electrode tabs 12, and the two electrode tabs 12 protrude from a top side of the battery core 11. It should be noted that the battery cell 10 is an aluminum foil packaged battery cell, and the description of the internal structure is omitted here for brevity.

The metal housing 20 includes a heat dissipation surface 21 with a large area (continuous plane) contacting (attached to) the battery core 11 and a frame 22 surrounding the heat dissipation surface 21. The heat generated by the battery core 11 may be dissipated through the attached metal housing 20 to achieve the effect of temperature homogeneity. Additionally, a buffer space 200 recessed toward the battery cell is formed between the frame 22 and the heat dissipation surface 21. Moreover, a plurality of cooling slots 23 are disposed on the frame 22 and communicate with the buffer space 200 and an external environment.

Specifically, the metal housing 20 has a first casing 201 and a second casing 202 opposite the first casing 201. In some embodiments, the metal housing 20 is an aluminum shell, but it is not restricted in actual implementation. In this embodiment, the frame 22 includes a pair of side-frames 221 disposed opposite to each other, and the cooling slots 23 are arranged spacedly on the pair of side-frames 221.

In one embodiment of this disclosure, the heat dissipation structure 1 further includes a thermal conductive layer 30. The thermal conductive layer 30 is disposed between the metal housing 20 and the battery core 11. In some embodiments, the thermal conductive layer 30 is a thermal conductive material such as thermal conductive adhesive. In this embodiment, a thermal conductive layer is disposed between the metal housing 20 and two sides of the battery core 11 separately. The metal housing 20 and the battery core 11 are combined through the thermal conductive layer 30.

Moreover, the heat dissipation structure 1 further includes a plurality of buffer sheets 40. The buffer sheets 40 are disposed between the frame 22 of the metal housings 20 and the battery core 11.

In more detail, the buffer sheets 40 include a plurality of buffer side plates 41, a buffer bottom plate 42 and a plurality of buffer strips 43. The buffer side plates 41 are located at two sides of the core battery 11. The buffer bottom plate 42 is located at a bottom side of the battery core 11. The buffer strips 43 are arranged parallelly between the buffer bottom plate 42 and a bottom side of the battery core 11.

It should be noted that the heat dissipation structure 1 may make the battery core 11 to be firmly fixed in the metal housing 20 through the arrangement of the buffer sheets 40.

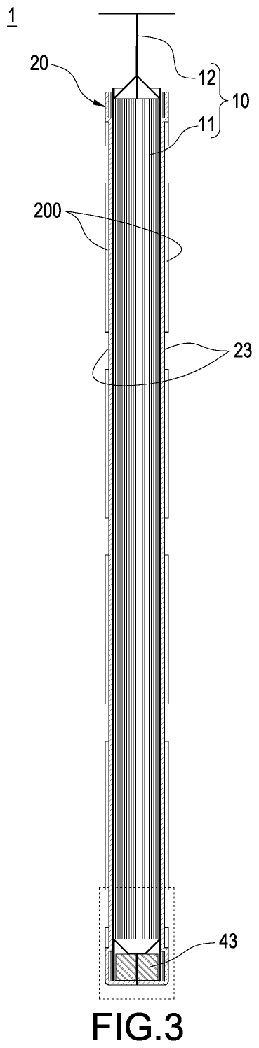

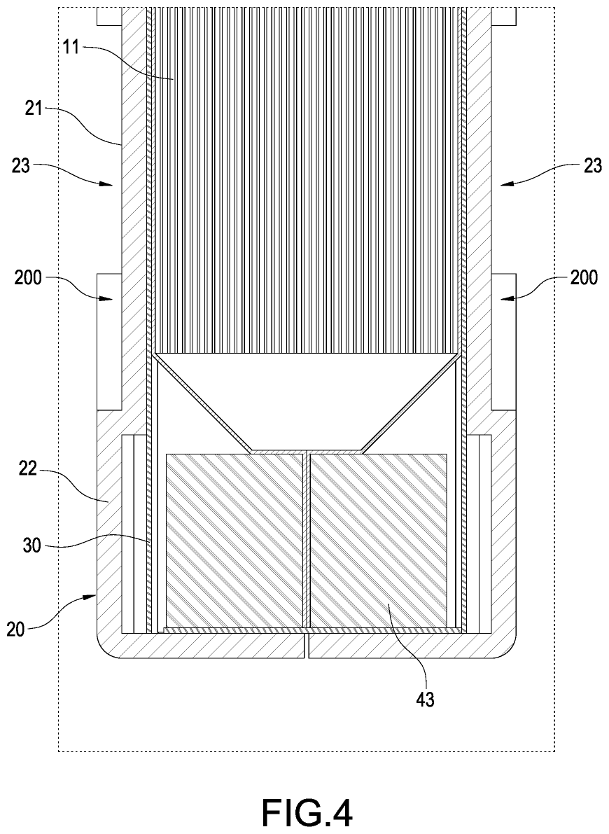

Please further refer to FIG. 3 and FIG. 4, which depict a cross sectional view of the heat dissipation structure of this disclosure and a partially enlarged view of FIG. 3. Referring to FIG. 3, the two electrode tabs 12 protrude between the first casing 201 and the second casing 202. Additionally, referring to FIG. 4, a buffer space 200 recessed toward the battery cell 10 is formed between the frame 22 of the metal housing 20 and the heat dissipation surface 21. In more detail, the first casing 201 and the second casing 202 cover the battery core 11 and have a buffer space 200 separately. Accordingly, when the battery core 11 generates gas and the electrode tabs 12 expand or contract, they may expand to the buffer space 200. Because of the arrangement of the buffer space 200, the battery core 11 and the electrode tabs 12 may not push the metal housing 20 after expansion and contraction, and the electrode tabs 12 have a certain clamping force so that the overall appearance of the battery cell 10 may be maintained. Moreover, the heat generated by the battery core 11 may be dissipated through the attached metal housing 20 to achieve the effect of temperature homogeneity and heat dissipation.

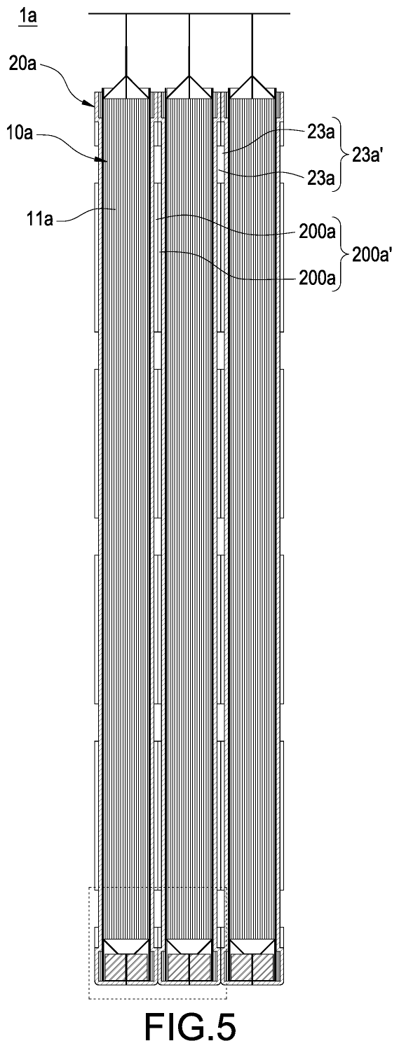

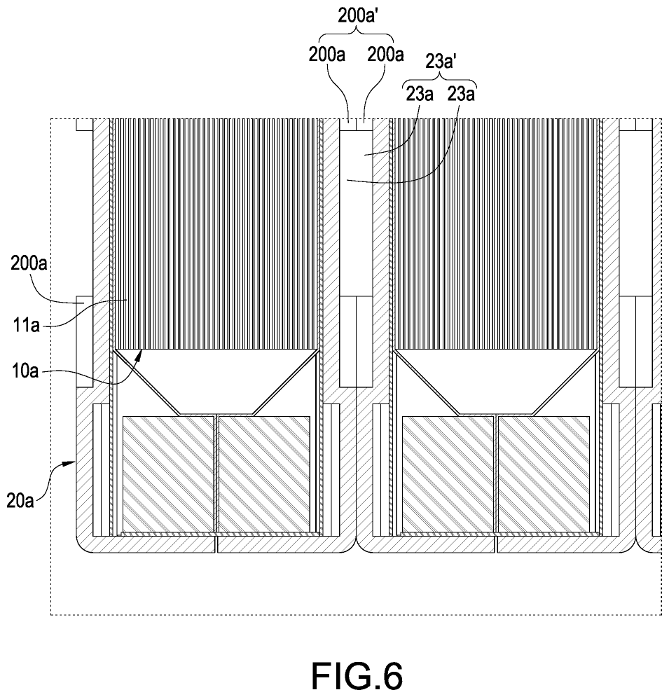

Please further refer to FIG. 5 and FIG. 6, they depict a cross sectional view and of another embodiment of the temperature equalization and heat dissipation structure and a partially enlarged view of FIG. 5. As shown in FIG. 5, a quantity of the battery core 10a and a quantity of the metal housing 20a of the heat dissipation structure la of this disclosure are multiple. The battery cells 10a are stacked with each other, and each metal housing 20a has a buffer space 200a and a plurality of cooling slots 23a between adjacent battery cores 11a.

Moreover, buffer spaces 200a of adjacent battery cores 11a are formed an expansion space 200a′ together to provide an expansion space 200a′ and a plurality of connected cooling slots 23a′. Accordingly, the expansion space 200a′ is provided for adjacent battery cores 11a when the adjacent battery core 11a generates gas and expands. It is worth of noticing that the disposition of the expansion space 200a′ may prevent the battery core 11a and the electrode tabs from pushing the metal housings 20a after expansion and contraction, therefore the overall appearance of the battery cells 10a may be maintained.

Therefore, the heat generated by the battery cores 11a may be quickly discharged from the cooling slots 23a′ to the external environment for heat dissipation, thereby reducing the overall temperature of the battery core 10a.

In this embodiment, outer sides of the outermost metal housing 20a of the heat dissipation structure la have a buffer space 200a recessed toward the battery cell 10a separately. In actual implementation, the outermost battery cell 10a may provide with a metal housing 20a only at one side. That is, an outer surface of the outermost battery cell 10a does not have a buffer space 200a.

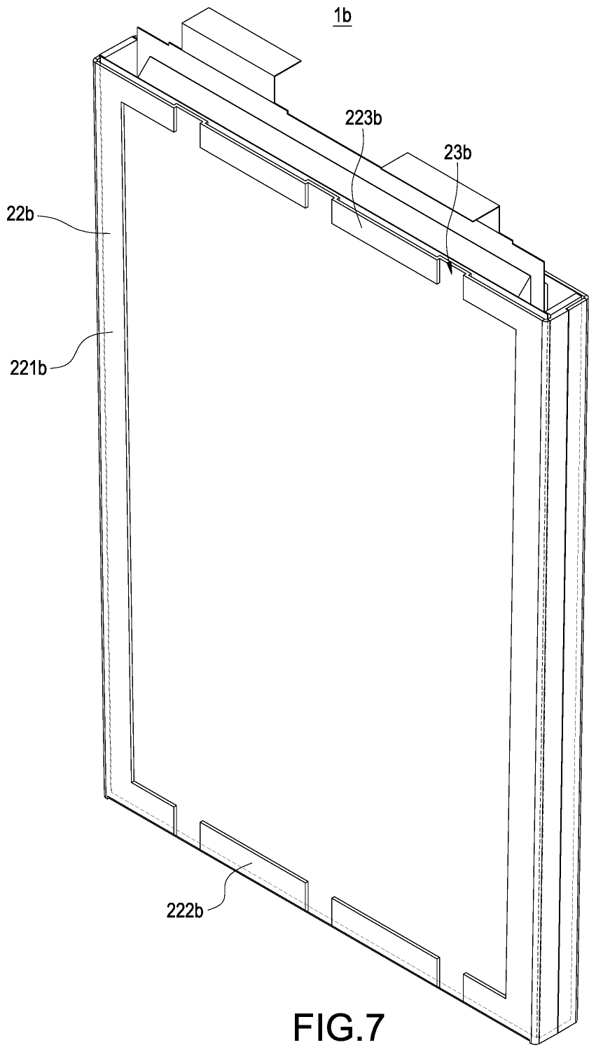

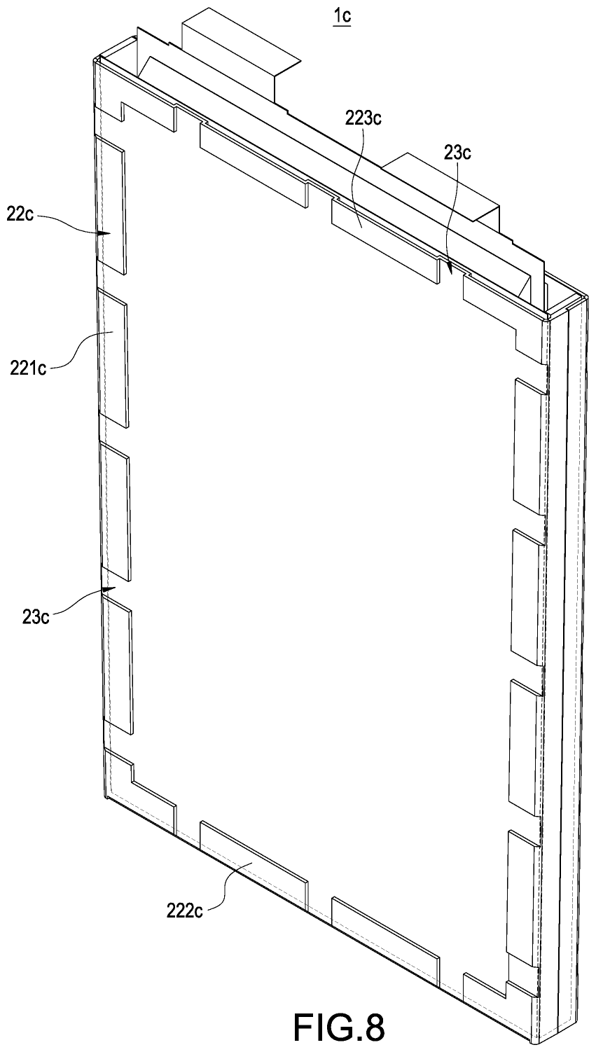

Please further refer to FIG. 7 and FIG. 8, which are perspective schematic views of another two embodiments of the heat dissipation structure of this disclosure. As shown in FIG. 7, taking one side of the heat dissipation structure 1b as an example, the frame 22b includes a lower frame 222b and an upper frame 223b adjacent to a pair of side-frames 221b respectively. Furthermore, a plurality of cooling slots 23b are arranged spacedly on the lower frame 222b and the upper frame 223b. Please refer to FIG. 8, a plurality of cooling slots 23c of the heat dissipation structure 1c are disposed spacedly on a pair of side-frames 221c, a lower frame 222c and an upper frame 223c.

It should be noted that the number and positions of the aforementioned cooling slots 23, 23a, 23b, and 23c are not limited, and may be adjusted according to actual requirements.

Although this disclosure has been described with reference to some embodiment thereof, it will be understood that the disclosure is not limited to the details thereof. Various substitutions and improvements have been suggested in the foregoing description, and others will occur to those of ordinary skill in the art. Therefore, all such substitutions and improvements are intended to be embraced within the scope of the disclosure as defined in the appended claims.

What is claimed is:

1. A heat dissipation structure of a lithium battery, the heat dissipation structure comprising:
a battery cell, comprising a battery core and two electrode tabs; and
a metal housing, comprising a heat dissipation surface attached to the battery core and a frame surrounding the heat dissipation surface, wherein a buffer space is defined concavely toward the battery cell between the frame and the heat dissipation surface, and a plurality of cooling slots are defined on the frame and communicate with the buffer space and an external environment.

2. The heat dissipation structure according to claim 1, wherein the metal housing comprises a first casing and a second casing opposite to each other; the first casing and the second casing cover the battery core and respectively have the buffer space; and the two electrode tabs are disposed protrusively between the first casing and the second casing.

3. The heat dissipation structure according to claim 1, further comprising a thermal conductive layer disposed between the metal housing and the battery core.

4. The heat dissipation structure according to claim 3, wherein the thermal conductive layer is a thermal conductive adhesive.

5. The heat dissipation structure according to claim 1, further comprising a plurality of buffer sheets disposed between the frame of the metal housing and the battery core.

6. The heat dissipation structure according to claim 5, wherein the buffer sheets include a plurality of buffer side plates, a buffer bottom plate, and a plurality of buffer strips; the buffer side plates are located at two sides of the battery core; the buffer bottom plate is located at a bottom side of the battery core; and the buffer strips are arranged parallelly between the buffer bottom plate and a bottom side of the battery core.

7. The heat dissipation structure according to claim 1, wherein the frame comprises a pair of side-frames disposed opposite to each other, and the cooling slots are arranged spacedly on the pair of side-frames.

8. The heat dissipation structure according to claim 1 wherein the frame comprises a lower frame and an upper frame opposite to each other, and the cooling slots are arranged spacedly on the lower frame and the upper frame.

9. The heat dissipation structure according to claim 1, wherein the battery cell and the metal casing are multiple in number; a plurality of battery cells is stacked with each other, and the buffer space is defined between two battery cores adjacent to each other, and an expansion space and the cooling slots connected together are defined by the buffer space of the battery cores adjacent to each other.

10. The heat dissipation structure according to claim 9, wherein the buffer space is defined concavely toward the battery cell on an outer side of an outermost metal housing.
